(19) United States
(12) Patent Application Publication
(10) Pub. No.: US 2024/0254013 A1
(43) Pub. Date: Aug. 1, 2024

(54) POLYMERIC FOAM COMPOSITES FOR WASTEWATER TREATMENT AT ROOM TEMPERATURE

(71) Applicant: QATAR UNIVERSITY, Doha (QA)

(72) Inventors: Aboubakr Moustafa ABDULLAH, Giza (EG); Kamel Abdelmoniem MOHAMED EID, Bellies Sharkia (EG); Yasseen Saeed Abdelfattah Mohamed IBRAHIM, MasrAlgdeda (EG); Yassmin Ahmed Ismail IBRAHIM, Almansoora (EG); Ahmed Abdelfattah Ahmed Mohamed ELZATAHRY, Nabeel Altwabik Faidal (EG)

(21) Appl. No.: 18/102,626

(22) Filed: Jan. 27, 2023

(51) Int. Cl. C02F 1/28; C08J 9/00; C08J 9/35; C08J 9/40; C08K 3/14; C08K 5/1545; C08K 5/16

(52) U.S. Cl. CPC C02F 1/288; C08J 9/0066; C08J 9/0085; C08J 9/35; C08J 9/405; C08K 3/14; C08K 5/1545; C08K 5/16; C08J 2205/022; C08J 2205/044; C08J 2375/16

(57) ABSTRACT

Provided herein are novel foam composites comprising a chitosan-cellulose-MXene hydrogel that has been adsorbed into a foam. Hydrophilic surface-modified two-dimensional MXenes nanosheets integrated into one-dimensional activated cellulose microfibers and three-dimensional neutralized chitosan hydrogel are adsorbed into a foam, for example polyurethane foam, to create the foam composites. Also described herein are the use of the foam composites for the purification of water, including the removal of at least one heavy metal.

### FIELD

Provided herein are novel foam composites comprising a chitosan-cellulose-MXene hydrogel adsorbed into a foam. Hydrophilic surface-modified two-dimensional MXenes nanosheets integrated into one-dimensional activated cellulose microfibers and three-dimensional neutralized chitosan hydrogel are adsorbed into a foam, for example polyurethane foam, to create the foam composites. Also described herein are the use of the foam composites for the purification of water, including the removal of at least one heavy metal.

### BACKGROUND

MXenes are a class of 2-D transition metal carbide, nitride, or carbonitride inorganic compounds that were first discovered in 2011. MXenes, which have the general formula Mₙ₊₁XₙTₓ where M is an early transition metal, X is carbon and/or nitrogen, and T is a functional group (typically O, OH, and/or F) on the surface of the MXene, are a few layers thick and have the appearance of fine, flaky pastry dough under a scanning electron microscope. The conductive carbide core means that MXenes have high metallic conductivity, but unlike other 2-D materials, they are also hydrophilic because of their hydroxyl- and oxygen-functionalized surfaces. The first MXene discovered was Ti₃C₂ (Naguib, M. et al. ACS Nano 2012, 6, 1322), and in the last several years, over two dozen MXenes have been synthesized (Anasori et al. Nature Reviews Materials, 2017, 2, 16098) for various applications, including electrochemical capacitors, sensors, energy storage, electronics, and catalysis.

While various MXene-based materials have also been used individually or with other composites as adsorbents for the removal of toxic pollutants, including lead, copper, barium, chromium, cadmium, mercury, uranium, and phosphate, these composites take a long-time (from several minutes to several hours) to achieve complete adsorption. Also, their use typically requires multiple preparation steps, and they can only be used in small quantities, which precludes their use in large-scale applications. The use of MXene-based hydrogels for water purification is described in U.S. Pat. No. 11,311,843 assigned to Qatar University.

Alternative technologies for water purification or treatment include physical adsorption, photocatalytic degradation, electrocoagulation, membrane filtration, and electrochemical techniques. However, these often require complicated steps and/or special laboratory techniques. They are also often high cost-operations (i.e., heating, pressure, and electricity, etc.), especially in large-scale applications.

Given that water is the most important natural resource and 97% of water is saline, it would be useful to provide new compositions for water treatment that can be easily prepared in a high yield from abundant, green, and inexpensive resources. It would also be beneficial to provide porous foam compositions that are capable of the complete removal of toxic metals at ambient temperature and zero pressure in a minimal amount of time.

### SUMMARY OF THE INVENTION

Described herein are foam composites comprising a chitosan-cellulose-MXene hydrogel adsorbed into a polymer-based foam. Hydrophilic two-dimensional MXenes nanosheets surface distributed in between one-dimensional activated cellulose microfibers and three-dimensional neutralized chitosan hydrogel are adsorbed into the foam, for example, polyurethane foam, to form the foam composites. In one embodiment, polyurethane foam is soaked in a composite gel comprising cellulose, chitosan and MXene. The foam easily absorbs the gel because the foam contains pores with sizes of about 1-5 mm, while the size of the MXene is about 200 nm, the cellulose is about 200 nm diameter/3 mm in length, and the chitosan flakes are about 5 μm. The foam composites described herein combine the unique physiochemical merits of hybrid hydrophilic (metal carbide) and hydrophobic (chitosan, cellulose, and polyurethane foam) materials in combination with porous form. The foam composites are advantageous for green water treatment, and the foam in particular allows for the efficient removal of toxins and heavy metals of various sizes.

Also described herein is a simple one-step method for water purification that occurs within a few seconds at room temperature, zero-electricity, and atmospheric pressure using the novel foam composites described herein. Unlike previous approaches that need several hours to remove toxic metals, under certain embodiments, and as described below, water purification using the foam composites described herein results in the complete removal of Cd and/or Zn within about 20 to 30 seconds at room temperature, atmospheric pressure, and using zero-electricity. The method of purifying water using the foam composites described herein can be used to purify, for example, industrial wastewater, agricultural wastewater, or household waste water.

Also described herein is a method for the synthesis of the foam composites that comprises adding dropwise an aqueous solution of the MXenes nanosheets and cellulose microfibers into an aqueous solution of chitosan to form the chitosan-cellulose-MXene hydrogel that is then adsorbed into a foam to afford the foam composites.

It is, in part, this simple synthesis that renders the foam composites described herein easy to use and cost effective. The simple synthesis and the use of cost-effective, green, and abundant materials makes these foam composites highly practical for general utilization in the industrial, agriculture, and household sectors.

### BRIEF DESCRIPTION OF FIGURES

FIG. 1A is the optical micrograph image of the polyurethane foam (PUF) used to synthesize the foam composite as described in Example 1.

FIG. 1B is the low-magnification SEM image of the PUF where the scale is 1 mm.

FIG. 1C is the low-magnification SEM image of the PUF where the scale is 500 μm.

FIG. 2A is the optical micrograph image of the foam composite as described in Example 1.

FIG. 2B is the low-magnification SEM image of the foam composite where the scale is 1 mm.

FIG. 2C is the low-magnification SEM image of the foam composite where the scale is 500 μm.

FIG. 3A is a high-magnification SEM image of the foam composite showing the overall shape.

FIG. 3B is a high-magnification SEM image of the foam composite showing the overall shape.

FIG. 3C is a high-magnification SEM image of the foam composite showing the 1D cellulose fiber.

FIG. 3D is a high-magnification SEM image of the foam composite showing the 2D Ti₃C₂T nanosheets.

FIG. 4 is an EDX analysis of the foam composite showing that the foam composite comprises carbon, oxygen, fluorine, and titanium.

FIG. 5A is the XRD spectra of the unmodified PUF and the foam composite as described in Example 1. In FIG. 5A, “foam” refers to the unmodified PUF and “nanocomposite” refers to the foam composite.

FIG. 5B is the FTIR spectra of the unmodified PUF and the foam composite as described in Example 1. In FIG. 5B, “foam” refers to the unmodified PUF and “nanocomposite” refers to the foam composite.

FIG. 6 is a graph showing the adsorption ability of the foam composite to adsorb Cd and Zn from an acidic water solution containing H₂CdCl₂O (100 ppm) and (CH₃CO₂)₂Zn (100 ppm) as described in Example 2. The lines for Cd and Zn overlap.

FIG. 7 is a graph showing the adsorption ability of the foam composite to adsorb Cd and Zn from an alkaline water solution containing H₂CdCl₂O (100 ppm) and (CH₃CO₂)₂Zn (100 ppm) as described in Example 2.

FIG. 8 is a graph showing the adsorption ability of the foam composite to adsorb Cd and Zn from pH neutral water solution containing H₂CdCl₂O (100 ppm) and (CH₃CO₂)₂Zn (100 ppm) as described in Example 2. The lines for Cd and Zn overlap.

FIG. 9 is a graph showing the adsorption ability of the foam composite modified with —OH groups to adsorb Cd and Zn from an acidic water solution containing H₂CdCl₂O (100 ppm) and (CH₃CO₂)₂Zn (100 ppm) as described in Example 2.

### DETAILED DESCRIPTION

Described herein are novel foam composites comprising a chitosan-cellulose-MXene hydrogel adsorbed into a foam. The chitosan-cellulose-MXene hydrogel of the foam composite comprises hydrophilic two-dimensional MXenes nanosheets surface modified with hydroxyl-, oxygen-, and fluorine-terminated groups integrated into one-dimensional activated cellulose microfibers and three-dimensional neutralized chitosan hydrogel. The chitosan-cellulose-MXene hydrogel is then mixed with polyurethane foam prior to annealing to form the foam composites.

In certain embodiments, the foam composites as described herein can be directly used as adsorbents for prompt, for example in about 30 seconds or less, and efficient removal of toxic metals (including, but not limited to, Cd, Zn, and Co, mixed or individualized), and inorganic pollutants from wastewater. Importantly, the treatment can be conducted at room temperature, under zero-pressure, and with zero-electricity.

The current approaches for water treatment, such as adsorption, photocatalytic degradation, chemical oxidation, membrane filtration, and electrochemical techniques involve multiple steps, and can require heating, pressure, and electricity in addition to special laboratory equipment or skills. This is in contrast to the foam composites described herein that, in certain embodiments, can treat wastewater in a simple one-step process at room temperature, zero-pressure, and zero-electricity without the need for special laboratory technique. In certain embodiments, the foam composites as described herein can be easily integrated or combined with other techniques such as electrocoagulation (to remove organic and inorganic pollutants) and capacitive deionization (to remove soluble salts, phosphates, and carbonates).

### Definitions

The terms “a” and “an” do not denote a limitation of quantity, but rather denote the presence of at least one of the referenced item. The term “or” means “and/or”. Recitation of ranges of values merely intend to serve as a shorthand method of referring individually to each separate value falling within the range, unless otherwise indicated herein, and each separate value is incorporated into the specification as if it were individually recited herein. The endpoints of all ranges are included within the range and independently combinable. All processes described herein can be performed in a suitable order unless otherwise indicated herein or otherwise clearly contradicted by context. The use of example, or exemplary language (e.g., “such as”), is intended merely to better illustrate the invention and does not pose a limitation on the scope of the invention on unless otherwise claimed.

As used herein, “independently” refers to the relationship among multiple instances of the same variable when selected from the same set of possibilities (e.g., a Markush group). For example, if the variable X is selected independently from the group consisting of a, b, and c, each instance of X in a structure can be the same as (e.g., all “a”) or be different from any other instance of X (e.g., for three “X,” one “b” and two “a” or any other combination of a, b, and c). Typically, for at least some embodiments of a group as disclosed herein (e.g., “A, B, or C”; “the member selected from the group consisting of A, B, and C”), members of the group are (1) independently selected from the alternatives and (2) groups do not exclude the possibility of embodiments comprising combinations of the individual group members.

As used herein, “or” is not exclusive (i.e., “or” may be equivalent to “and/or”). For example, an aspect comprising “A, B, or C” may present embodiments with A, B, C, A in combination with B, B in combination with C, A in combination with C, or all three (A, B, and C) in combination.

The term “MXene” refers to a hydrophilic two-dimensional nanosheet that consists of metal carbides, nitrides, or carbonitrides. In certain embodiments, the MXene is approximately 200 nm×100 nm with a thickness between about 1 nm and 2 nm.

As used herein, “activation” or “activated” refers to treatment of a chemical substance to improve the chemical properties of the chemical substance compared to the chemical properties of the chemical substance before such treatment. For example, an activated chemical substance has chemical properties that are better and/or more useful than the corresponding chemical substance or educt in unactivated form.

As used herein, “nanosheets” refers to nanoscale particles (particles having a size of less than 100 nm) arranged in the form of sheets or layers of the nanoscale particles.

As used herein, “hydrogel” refers to cross-linked hydrophilic polymers that maintain structural integrity when dispersed in water.

As used herein, “halogen” refers to fluorine (F), chlorine (Cl), bromine (Br), or iodine (I).

As used herein, “industrial wastewater” refers to water waste derived from industrial scale (e.g., metric ton) oil, gas, and petroleum processing.

As used herein, “domestic wastewater” or “household wastewater” refers to water waste derived from, for example, household use.

As used herein, “heavy metals” refers to any metallic chemical element that has a relatively high density and is toxic or poisonous at low concentrations. Examples of heavy metals include, without limitation, mercury (Hg), cadmium (Cd), zinc (Zn), arsenic (As), chromium (Cr), thallium (TI), and lead (Pb).

As used herein “one-dimensional” nanomaterials (e.g., nanosheets) refer to nanomaterials where at least one dimension is outside of the nanoscale. For example, in certain embodiments, when one dimension of the nanomaterial is larger than 100 nm. In certain embodiments, one-dimensional nanomaterials are nanosheets.

As used herein “two-dimensional” nanomaterials (e.g., nanosheets) refer to nanomaterials where at least two dimensions are outside the nanoscale. For example, in certain embodiments, when two dimensions of the nanomaterial are larger than 100 nm. In certain embodiments, two-dimensional nanomaterials are plate-like shapes. In certain embodiments, two-dimensional nanomaterials include, without limitation, nanofilms, nanolayers, and nanocoatings.

As used herein, “three-dimensional” materials refer to materials where each dimension is outside the nanoscale. For example, in certain embodiments, three-dimensional materials include, without limitation, chitosan.

### Foam Composites

The foam composites described herein comprise a chitosan-cellulose-MXene hydrogel adsorbed into a foam, for example a polymer-based foam. The chitosan-cellulose-MXene hydrogel of the foam composites comprises hydrophilic two-dimensional MXenes nanosheets surface modified with hydroxyl-, oxygen-, and fluorine-terminated groups integrated into one-dimensional activated cellulose microfibers and three-dimensional neutralized chitosan hydrogel.

The foam composites described herein combine the unique physiochemical merits of functionalized Mxenes, activated 1D cellulose, chitosan hydrogel and a porous foam, and the foam in particular is advantageous because it provides feasibility for a large-scale operation, is low in cost, has high adsorption affinity, and is easy to recycle. The functionalized MXenes provide high surface area, electrical conductivity, hydrophilicity, abundant OH groups, and abundant adsorption sites. These MXenes help to promote ion exchange, diffusion rate, swelling properties, and provide massive adsorption for the pollutants. The activated 1D cellulose is electron-rich, has a high aspect ratio, provides accessible active adsorption sites, and is hydrophobic. Activation of the cellulose provides massive adsorption or exchange sites for toxic/heavy metals and organic/inorganic pollutants. The chitosan hydrogel is antimicrobial, hydrophobic, is composed of abundant amino/hydroxyl/ether groups that provide for strong intercalation with metals, and is safe. The strong cation exchange of chitosan induces the quick and efficient adsorption of various pollutants at room temperature, while the antimicrobial activity allows for disinfection of water and the removal of pollutants. Importantly, the porous foam with high porosity volume and a wide range of pore sizes allows for the efficient removal of toxins and heavy metals of various sizes.

The foam composite is porous. In one embodiment, the average pore size is between about 1 mm and 5 mm. In one embodiment, the average pore size is between about 1 mm and 3 mm. In one embodiment, the average pore size is between about 2 mm and 4 mm. In one embodiment, the average pore size is at less than about 5 mm, less than about 4 mm, less than about 3 mm, less than about 2 mm, less than about 1 mm, or less than about 0.5 mm.

In one embodiment, the average pore diameter of the foam is between about 500 μm and 50 μm. In one embodiment, the average pore diameter of the foam is between about 450 μm and 100 μm. In one embodiment, the average pore diameter of the foam is between about 400 μm and 150 μm. In one embodiment, the average pore diameter of the foam is between about 350 μm and 200 μm. In one embodiment, the average pore diameter of the foam is between about 300 μm and 250 μm. In one embodiment, the average pore diameter of the foam is less than about 500 μm, less than about 400 μm, less than about 300 μm, less than about 250 μm, less than about 200 μm, less than about 150 μm, less than about 100 μm, or less than about 50 μm. In certain embodiments, the average pore diameter may vary by ±10 μm.

In one embodiment, the pore volume is between about 70% and 95%. In one embodiment, the pore volume is between about 75% and 90% or about 80% and 90%. In one embodiment, the pore volume is at least about 70%, at least about 75%, at least about 80%, at least about 85%, at least about 90%, or at least about 95%.

In certain embodiments, the average pore diameter of the foam composite is between about 210 μm and 190 μm. In one embodiment, the average pore diameter of the foam composite is about 200 μm.

The foam composites described herein are degradable, green, and easy to handle. Additionally, the foam composites described herein can be in synthesized in high yield under both small-scale (several centimeters) and large scale (several meters) conditions. Further, they can be easily prepared from a wide variety of natural, abundant, and inexpensive material.

The MXene of the foam composite is characterized by the formula Mₙ₊₁XₙTₓ where M is an early transition metal selected from scandium (Sc), titanium (Ti), vanadium (V), chromium (Cr), zirconium (Zr), niobium (Nb), molybdenum (Mo), mercury (Hf), and tantalum (Ta); X is carbon and/or nitrogen; and, Tₓ is a functional group on the surface of the MXene (typically oxygen-, hydroxyl- and fluorine-terminating groups).

In one embodiment, the MXene of the foam composite has the formula M₂XTₓ. In one embodiment, the MXene of the foam composite has the formula M₃X₂Tₓ. In one embodiment, the MXene of the foam composite has the formula M₄X₃Tₓ.

In a preferred embodiment, the MXene of the foam composite has the formula Ti₃C₂Tₓ.

In one embodiment, the MXene of the foam composite is modified with functional groups selected from hydroxyl-, oxygen-, and fluorine-terminated groups. In one embodiment, the MXene of the foam composite is modified with hydroxyl-, oxygen-, and fluorine-terminated groups. In one embodiment, the MXene of the foam composite is modified with hydroxyl-terminated groups. In one embodiment, the MXene of the foam composite is modified with oxygen-terminated groups. In one embodiment, the MXene of the foam composite is modified with fluorine-terminated groups. In one embodiment, the MXene of the foam composite is not modified and has the formula Mₙ₊₁Xₙ, for example Ti₂C.

The MXene of the foam composite can be solid, porous, or mesoporous. The MXene is between about 1 nm and 2 nm thick. In one embodiment, the MXene is between about 1.5 and 2 nm thick.

In one embodiment, the cellulose of the foam composite is natural. In one embodiment, the cellulose is synthetic.

In certain embodiments, the chitosan of the foam composite can be further modified with a polymer or a cross-linker. In one embodiment, the polymer is a hydrophilic or hydrophobic polymer. Alternatively, the polymer can be an ionic or nonionic polymer. Non-limiting examples of cross-linking agents include glutaraldehyde, epoxy chloropropane, epoxy propyl trimethylammonium chloride, trimesoyl chloride, phthaloyl chloride, isophthaloyl dichloride, paraphthaloyl chloride, or hexanedioyl chloride.

In one embodiment, a carbon-based material, including, but not limited to, carbon-nitride, carbon-dots, carbon nanotubes, a metal organic framework, zeolite, or graphene can be used with the foam nanocomposites described herein.

The chitosan-cellulose-MXene hydrogel is mixed with foam prior to annealing to form the foam composite. In certain embodiments, the foam is polyurethane foam. In alternative embodiments, the foam is another polymer-based foam, including, but not limited to polyethylene (PE)-, polystyrene (PS)-, and polypropylene (PP)-based foam.

The foam composites can be characterized by high annular dark-field SEM imaging and/or EDS elemental mapping analysis. The foam composites can also be analyzed by EDX (energy dispersive X-ray analysis). In one embodiment, the atomic ratio of carbon:titanium:oxygen:fluorine (C:Ti:O:F) of the foam composite as measured by EDX is about 80:14:5:1.

In one embodiment, the foam composite is characterized by an atomic percentage of carbon as measured by EDX between about 90% and about 70%. In one embodiment, the foam composite is characterized by an atomic percentage of carbon as measured by EDX of at least about 70%, at least about 75%, at least about 80%, at least about 85%, or at least about 90%. In one embodiment, foam composite is characterized by an atomic percentage of carbon as measured by EDX of about 80%.

In one embodiment, the foam composite is characterized by an atomic percentage of titanium as measured by EDX of at least about 10%, at least about 15%, or at least about 20%. In one embodiment, the foam composite is characterized by an atomic percentage of titanium as measured by EDX of about 14%.

In one embodiment, the foam composite is characterized by an atomic percentage of oxygen as measured by EDX of at least about 10%, at least about 8%, at least about 5%, or at least about 3%. In one embodiment, the foam composite is characterized by an atomic percentage of oxygen as measured by EDX of about 5%.

In one embodiment, the foam composite is characterized by an atomic percentage of fluorine as measured by EDX of at least about 3%, at least about 2%, at least about 1%, or at least about 0.5%. In one embodiment, the foam composite is characterized by an atomic percentage of fluorine as measured by EDX of about 1%.

In one embodiment, the foam composite is amorphous as measured by X-ray diffraction analysis (XRD).

Also described herein is a method for the synthesis of the foam composite that comprises:
1) etching Ti₃C₂Al in a solution of HF to form the MXene Ti₃C₂T nanosheet as a powder;
2) synthesizing the 1D cellulose microfibers by dissolving cellulose powder in an aqueous solution of NaOH and subsequently drying under vacuum to afford a cellulose powder;
3) mixing the nanosheet powder and the cellulose powder in an aqueous solution, an inorganic solvent, an organic solvent, or a mixture thereof to afford an aqueous solution;
4) dissolving chitosan in an aqueous solution of acetic acid and adding the aqueous solution of nanosheet powder and cellulose powder dropwise to form a chitosan-cellulose-MXene hydrogel; and
5) adsorbing the chitosan-cellulose-MXene hydrogel into a foam via the impregnation approach and annealing to afford the foam composite.

In one embodiment, the etching in step 1 is conducted at room temperature.

In one embodiment, step 1 further comprises modifying the MXene Ti₃C₂T nanosheet by dissolving the powder in aqueous NaOH solution stirring and drying the subsequent powder to be used in step 2.

In one embodiment, the nanosheet powder and the cellulose powder are mixed in water in step 3.

In one embodiment, the foam is a polyurethane foam. In one embodiment, the annealing is conducted between about 50° C. and 120° C. In one embodiment, the annealing is conducted between about 60° C. and 110° C. In one embodiment, the annealing is conducted between about 70° C. and 100° C. In one embodiment, the annealing is conducted at 80° C.

### Methods of Wastewater Treatment

Another aspect of the current invention is a simple one-step method for the removal of toxic metals, such as heavy metals, mixed or individualized, within a few seconds at room temperature, zero-electricity, and atmospheric pressure using the foam composites described herein. For example, in one embodiment, the use of the foam composites described herein for wastewater treatment results in the complete removal of toxic metals within about 30 seconds at room temperature without heating, pressure, or electricity. In one embodiment, the use of the foam composites described herein for wastewater treatment results in the complete removal of heavy metals, mixed or individualized, within about 20-40 seconds at room temperature without heating, pressure, or electricity. The foam composites described herein can also be used for the removal of other organic (i.e., dyes, hydrocarbons, etc.) and inorganic pollutants (i.e., phosphate, sulfate, carbonate, etc.). In one embodiment, the foam composites described herein are used for the removal of zinc and/or cadmium.

The foam composites as described herein can also be used for water desalination under ambient conditions.

In one embodiment, the purification process is carried out for a solution of one heavy metal. In one embodiment, the purification process is carried out for a solution of more than one heavy metal.

In one embodiment, the foam composites described herein are used for the purification of water solution, wastewater, industrial wastewater, agricultural wastewater, or household water. The pH of the water can be acidic, alkaline, or neutral.

In certain embodiments, the water purification process is carried out simultaneously with disinfection.

In certain embodiments, including any of the foregoing, the foam composites described herein adsorb at least about 60% of the heavy metal from a water solution within less than about 5 minutes, less than about 4 minutes, less than about 3 minutes, less than about 2 minutes, less than about 1 minute, less than about 45 seconds, less than about 30 seconds, or less than about 15 seconds.

In certain embodiments, including any of the foregoing, the foam composites described herein adsorb at least about 65% of the heavy metal from a water solution within less than about 5 minutes, less than about 4 minutes, less than about 3 minutes, less than about 2 minutes, less than about 1 minute, less than about 45 seconds, less than about 30 seconds, or less than about 15 seconds.

In certain embodiments, including any of the foregoing, the foam composites described herein adsorb at least about 70% of the heavy metal from a water solution within less than about 5 minutes, less than about 4 minutes, less than about 3 minutes, less than about 2 minutes, less than about 1 minute, less than about 45 seconds, less than about 30 seconds, or less than about 15 seconds.

In certain embodiments, including any of the foregoing, the foam composites described herein adsorb at least about 75% of the heavy metal from a water solution within less than about 5 minutes, less than about 4 minutes, less than about 3 minutes, less than about 2 minutes, less than about 1 minute, less than about 45 seconds, less than about 30 seconds, or less than about 15 seconds.

In certain embodiments, including any of the foregoing, the foam composites described herein adsorb at least about 80% of the heavy metal from a water solution within less than about 5 minutes, less than about 4 minutes, less than about 3 minutes, less than about 2 minutes, less than about 1 minute, less than about 45 seconds, less than about 30 seconds, or less than about 15 seconds.

In certain embodiments, including any of the foregoing, the foam composites described herein adsorb at least about 85% of the heavy metal from a water solution within less than about 5 minutes, less than about 4 minutes, less than about 3 minutes, less than about 2 minutes, less than about 1 minute, less than about 45 seconds, less than about 30 seconds, or less than about 15 seconds.

In certain embodiments, including any of the foregoing, the foam composites described herein adsorb at least about 90% of the heavy metal from a water solution within less than about 5 minutes, less than about 4 minutes, less than about 3 minutes, less than about 2 minutes, less than about 1 minute, less than about 45 seconds, less than about 30 seconds, or less than about 15 seconds.

In certain embodiments, including any of the foregoing, the foam composites described herein adsorb at least about 95% of the heavy metal from a water solution within less than about 5 minutes, less than about 4 minutes, less than about 3 minutes, less than about 2 minutes, less than about 1 minute, less than about 45 seconds, less than about 30 seconds, or less than about 15 seconds.

In certain embodiments, including any of the foregoing, the foam composites described herein adsorb at least about 99% of the heavy metal from a water solution within less than about 5 minutes, less than about 4 minutes, less than about 3 minutes, less than about 2 minutes, less than about 1 minute, less than about 45 seconds, less than about 30 seconds, or less than about 15 seconds.

In certain embodiments, including any of the foregoing, the foam composites described herein adsorb about 100% of the heavy metal from a water solution within less than about 5 minutes, less than about 4 minutes, less than about 3 minutes, less than about 2 minutes, less than about 1 minute, less than about 45 seconds, less than about 30 seconds, or less than about 15 seconds.

In certain embodiments, including any of the foregoing, the water is acidic. In certain embodiments, including any of the foregoing, the water is alkaline. In certain embodiments, including any of the foregoing, the water is basic.

In certain embodiments, including any of the foregoing, the water comprises at least one heavy metal selected from zinc, cadmium, lead, chromium, copper, mercury, and barium. In one embodiment, including any of the foregoing, the water comprises zinc. In one embodiment, including any of the foregoing, the water comprises cadmium. In certain embodiments, including any of the foregoing, the water comprises both zinc and cadmium.

In one embodiment, the foam composites described herein adsorb at least about 75% of the heavy metal from an acidic water solution within less than about 20 seconds.

In one embodiment, the foam composites described herein adsorb at least about 95% of the heavy metal from an alkaline water solution within less than about 35 seconds.

In one embodiment, the foam composites described herein adsorb about 100% of the heavy metal from an alkaline water solution within less than about 20 seconds.

In one embodiment, the foam composites described herein adsorb about 100% of the heavy metal from a neutral water solution within less than about 20 seconds.

### Examples

Aluminum titanium carbide powder MAX-phase ((Ti₃AlC₂), 98%) was purchased from Carbon-Ukraine Ltd and dimethyl sulfoxide (DMSO, C₂H₆O_{S}, 99.7%) was obtained from Fisher Scientific International, Inc. Hydrofluoric acid, (HF, 48%) was obtained from VWR Chemicals BDH. Sodium hydroxide (NaOH, 99.9%), cellulose microcrystalline powder, (0.6 g/mL (25° C.)), acetic acid (≥99%), sodium hydroxide (≥97%) and chitosan (medium molecular weight) were purchased from Sigma-Aldrich Chemie GmbH (Munich, Germany). Ethanol solution (99%), cadmium chloride hydrated (99%), and polyurethane foam sheet, (0.08 g/cm³) were obtained from DongGuan Gao Yuan Shoes Material Co., Ltd. DongGuan, P.R. China.

### Example 1. Preparation of Chitosan-Cellulose-Ti₃C₂T Hydrogel Foam

### Modified 2D) MXene Nanosheets Preparation

For the typical preparation of modified two-dimensional Ti₃C₂T (T=F, O, OH) nanosheets, Ti₃C₂Al (1 g) was dispersed in 10 mL HF (48%) and stirred for 24 hours at room temperature followed by five centrifugation/washing cycles at 4000 rpm until the pH reached 5. The resulting powder was stirred with 12 mL of DMSO for 24 hours at room temperature before being centrifuged/washed with water at 3500 rpm five times to afford a powder. The powder was redispersed in H₂O under ultrasonic treatment at room temperature for 5 hours and then purified by centrifugation/washing cycles at 3500 rpm with H₂O five times to afford a powder that was freeze-dried at 50° C. for 5 hours.

To prepare the MXene with modified —OH groups, Ti₃C₂ (3 g) powder was mixed with 5% NaOH under stirring at room temperature for 4 hours and freeze-dried at 50° C. for 5 hours.

### Modified 1D Cellulose Fibers Preparation

Cellulose powder (10 g) was dissolved in a solution of 10 mL H₂O and 2 mL NaOH for 2 hours at room temperature followed by centrifugation/washing with H₂O and drying at 60° C. under vacuum. The resulting powder was mixed with the Ti₃C₂T powder and dispersed (0.6 g/mL) in water and then added dropwise to the chitosan solution. In an alternative embodiment, the power is dispersed in an inorganic solvent, an organic solvent, or a mixture thereof.

### Modified 3D Chitosan Hydrogel Preparation

Chitosan hydrogel was prepared by dissolving 4 g of chitosan in an aqueous solution of 100 mL acetic acid (20% v/v) under mechanical stirring at room temperature. Next, the aqueous solution of the 2D Ti₃C₂T nanosheets (2 g in 5 mL H₂O) and 1D cellulose fiber (1.2 gm in 2 mL H₂O) was added dropwise into the chitosan hydrogel under mechanical stirring and sonicated to afford a chitosan-cellulose-Ti₃C₂T hydrogel.

### Foam Preparation

For the preparation of the composite foam, the chitosan-cellulose-Ti₃C₂T hydrogel was adsorbed onto polyurethane foam (10 cm²) via the impregnation approach, dried at 80° C. under air, and then neutralized in NaOH solution (1 M) until the pH was 7. The foam was left to dry in air at 80° C. and kept for further utilization.

### Characterization

The foam composite was characterized by scanning electron microscope (SEM, Hitachi S-4800, Hitachi, Japan) equipped with an energy dispersive spectrometer (EDS). X-ray diffraction pattern (XRD) was investigated on an X-ray diffractometer (X Pert-Pro MPD, PANalytical Co., Netherland). The Fourier Transform Infrared (FTIR) was recorded on (FTIR, Shimadzu IR-Prestige21).

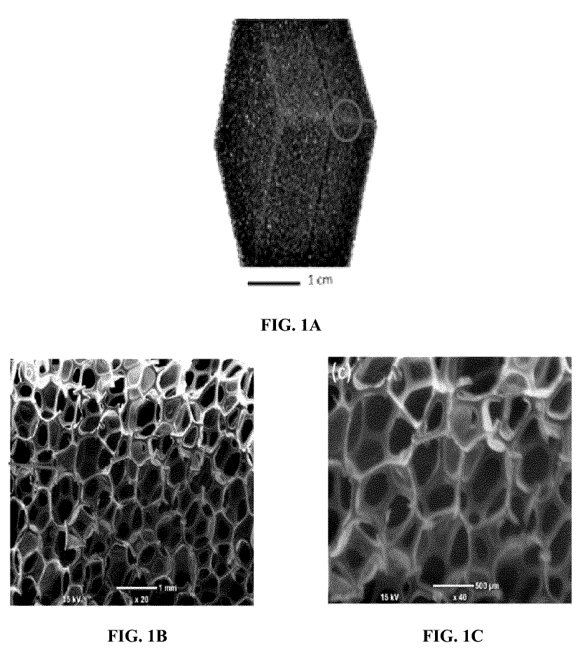

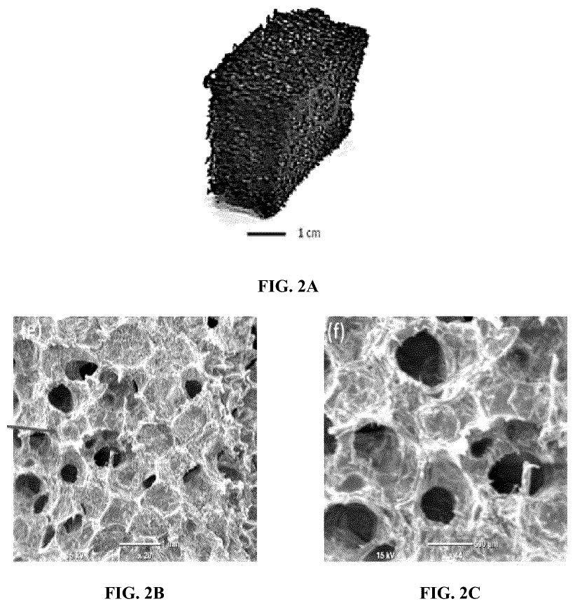

FIG. 1A shows the optical micrograph image of the as-received polyurethane foam (denoted as PUF) with as average dimeter of 5×2 cm. FIG. 1B and FIG. 1C display the low-magnification SEM images of PUF with its typical 3D open connected pores with average diameter of 500+50 μm. The PUF was used as a template for the formation of composites (denoted as foam composite). FIG. 2A shows the optical micrograph image of the foam composite and FIG. 2B-FIG. 2C are low-magnification SEM images of the foam composite.

As shown in the low-magnification SEM images FIG. 2B-FIG. 2C, the 3D interconnected pores of the foam composite are fully covered in the chitosan-cellulose-MXene hydrogel. The composite is also characterized by a significant decrease in pore volume and pore diameter compared to the PUF. The average pore diameter of the foam composite is in the range 200+10 μm. The interior wall of each pore of the foam composite is fully covered with 1D fiber-like and 2D sheet-like shapes. The small and multiple pore sizes of the foam composites described herein are advantageous for removing toxic metals with different atomic radii.

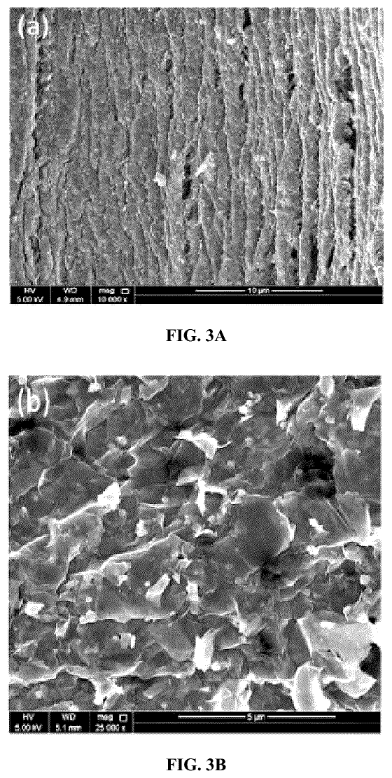

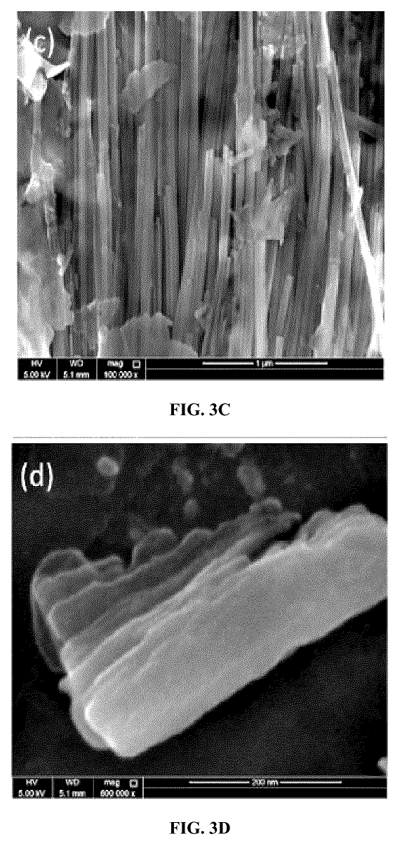

The high-magnification SEM image showed the 3D multi-layered structure of the composite inside the wall of pores (FIG. 3A-FIG. 3B). The higher magnification resolved the presence of the 1D cellulose fiber structure (FIG. 3C) and the 2D Ti₃C₂T nanosheets (FIG. 3D).

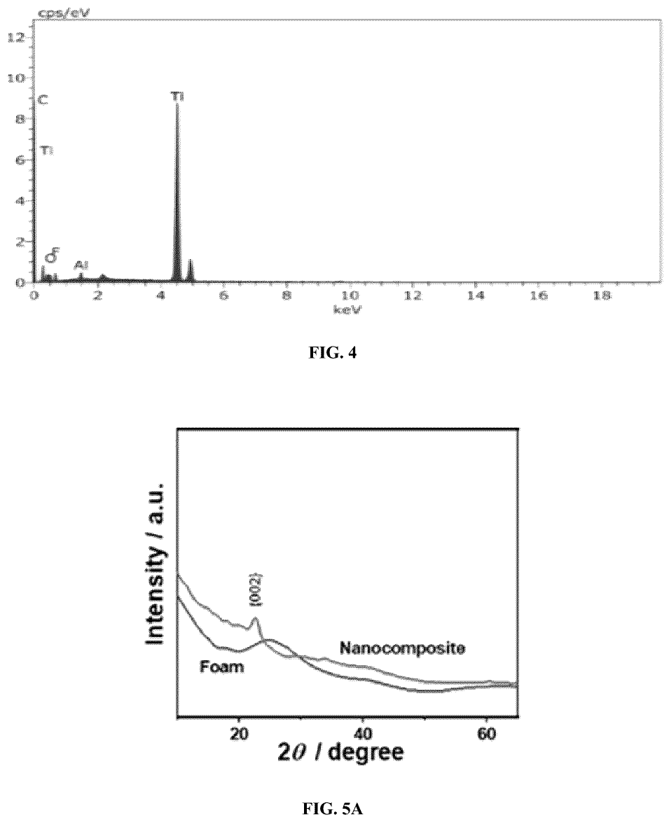

A high annular dark-field SEM and EDS elemental mapping analysis showed the composition of the formed composite. Elements titanium (Ti), carbon (C), oxygen (O), and fluorine (F) were coherently resolved and distributed within the composite. The atomic ratios of C, Ti, O, and F were about 79.8, 14.2, 4.9, and 1.1, respectively. This corresponded to the EDX analysis (FIG. 4).

FIG. 5A compares the XRD spectra of unmodified PUF to the composite foam. Both display the amorphous diffraction pattern attributed to 002 facet of carbon. FIG. 5B compares the FTIR spectra of unmodified PUF to the composite foam. The FTIR spectra of the unmodified PUF only reveled the main infrared spectrum of polyurethane foam including C═O, N—H, C—O—C, and C—H, while the FTIR spectra of the composite foam showed the main stretching vibration spectra assigned to N—H, C—O—C, C—N, CH—OH, OH, and C—H attributed to chitosan in addition to the main spectra of Ti—O, C—F, and C—C from the Ti₃C₂T MXene.

### Example 2. Removal Efficiency of Cadmium (Cd) and Zinc (Zn)

The composite foam was dipped in 200 mL aqueous solutions containing H₂CdCl₂O(100 ppm) and (CH₃CO₂)₂Zn (100 ppm) at 25° C. Standard buffer solutions were used to make solutions with pH values of about 4, 7.4, and 9. Every 10 seconds, an aliquot of the water solution (1 mL) was withdrawn and analyzed using inductively coupled plasma (ICP-OES & ICP-AES, PerkinElmer, USA). The removal efficiency was determined using the following equation:

$$Removal \% = [ ( {C}_{0} - {C}_{t} ) / {C}_{0} ] \times 100$$

where C₀ is the concentration at zero time and Ct is the measured concentration at a specific time.

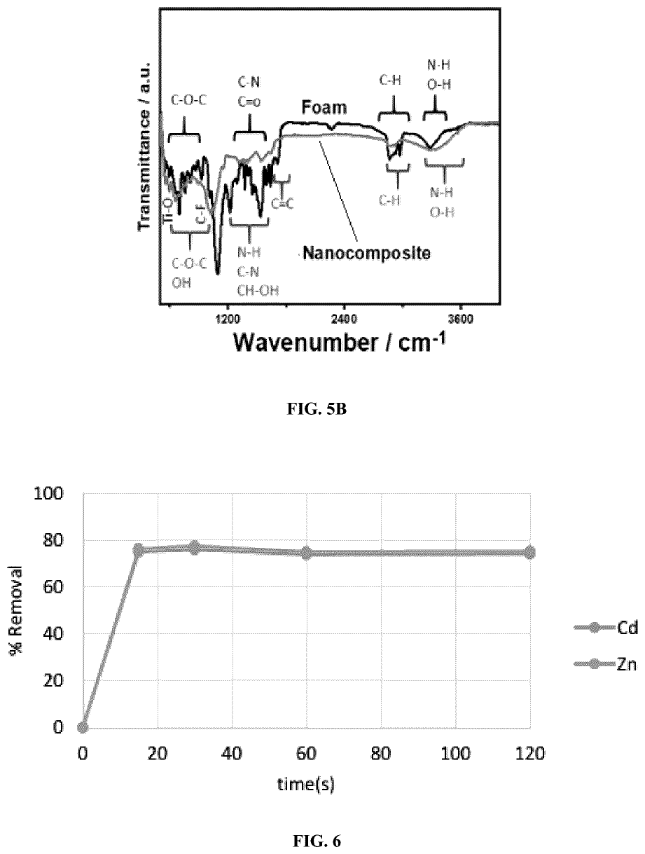

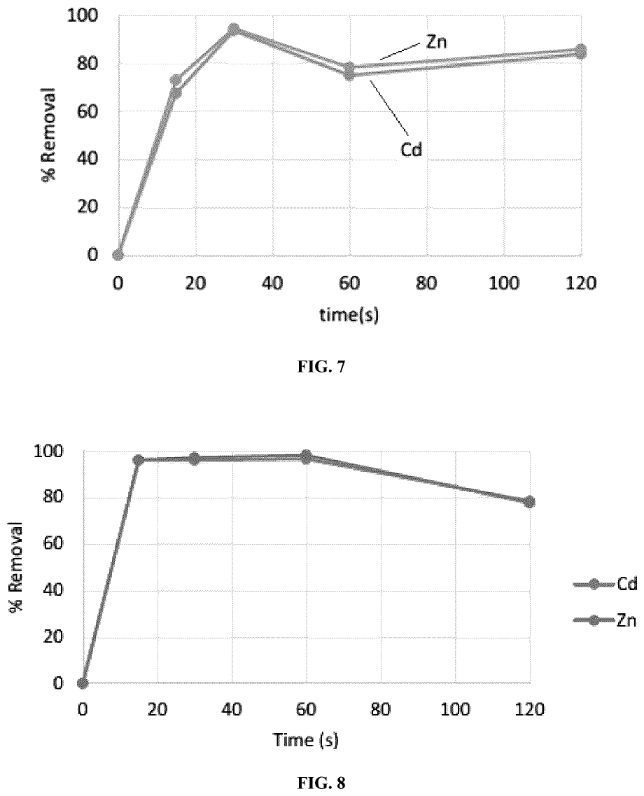

Under acidic conditions (pH=4), 78% of both metals were adsorbed by the composite foam within 18 seconds (FIG. 6) and under alkaline conditions (pH=9), 95% of both metals were adsorbed within 35 seconds (FIG. 7). At neutral conditions (pH=7.4), 100% of both metals were adsorbed within 18 seconds (FIG. 8). The removal efficiency of the foam was 3000 mg/g.

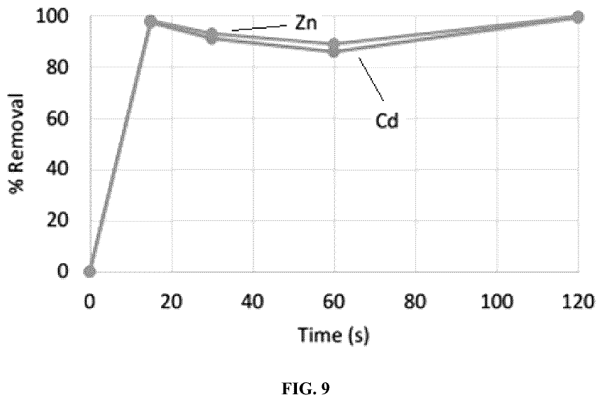

When the composite foam was modified with —OH groups, the foam was also efficient at removing Zn and Cd. Under alkaline conditions (pH=9), 100% of the both metals were adsorbed within 18 seconds (FIG. 9).

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A foam composite comprising a chitosan-cellulose-MXene hydrogel adsorbed into a polymer-based foam wherein the chitosan-cellulose-MXene hydrogel comprises hydrophilic surface-modified two-dimensional MXenes nanosheets integrated into one-dimensional activated cellulose microfibers and three-dimensional neutralized chitosan hydrogel.

2. The foam composite of claim 1, wherein the MXene nanosheets are of the formula: 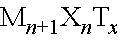
wherein
M is an early transition metal selected from scandium (Sc), titanium (Ti), vanadium (V), chromium (Cr), zirconium (Zr), niobium (Nb), molybdenum (Mo), mercury (Hf), and tantalum (Ta);
X is carbon and/or nitrogen; and,
Tₓ is a hydroxyl, oxygen, and/or fluorine-terminating functional group on the surface of the MXene.

3. The foam composite of claim 2, wherein the MXene nanosheets are of the formula M₃X₂Tₓ.

4. The foam composite of claim 1, wherein the polymer-based foam comprises polyurethane.

5. The foam composite of claim 1, characterized by an atomic percentage of carbon as measured by EDX of about 70%.

6. The foam composite of claim 1, characterized by an atomic percentage of titanium as measured by EDX of about 10%.

7. The foam composite of claim 1, characterized by an atomic percentage of oxygen as measured by EDX of about 5%.

8. The foam composite of claim 1, characterized by an atomic percentage of fluorine as measured by EDX of about 1%.

9. The foam composite of claim 1, wherein the atomic ratio of carbon:titanium:oxygen:fluorine (C:Ti:O:F) of the foam composite as measured by EDX is about 80:14:5:1.

10. The foam composite of claim 1, wherein the foam composite is porous and the average pore diameter of the foam is between about 250 μm and 150 μm.

11. The foam composite of claim 1, wherein the foam composite is porous and the average pore diameter of the foam is between about 210 μm and 190 μm.

12. The foam composite of claim 1, for the removal of at least one heavy metal from water wherein the at least one heavy metal is selected from zinc, cadmium, lead, chromium, copper, mercury, and barium.

13. The foam composite of claim 12, wherein the removal of at least one heavy metal from water is conducted at room temperature, atmospheric pressure, and without electricity.

14. The foam composite of claim 12, wherein the foam composite adsorbs at least about 70% of the at least one heavy metal from the water within less than about 5 minutes.

15. The foam composite of claim 12, wherein the foam composite adsorbs at least about 80% of the at least one heavy metal from the water within less than about 5 minutes.

16. The foam composite of claim 12, wherein the foam composite adsorbs at least about 90% of the at least one heavy metal from the water within less than about 5 minutes.

17. The foam composite of claim 12, wherein the foam composite adsorbs at least about 95% of the at least one heavy metal from the water within less than about 5 minutes.

18. The foam composite of claim 12, wherein the foam composite adsorbs about 100% of the at least one heavy metal from the water within less than about 5 minutes.

19. The foam composite of claim 12, wherein the at least one heavy metal is adsorbed from the water within less than 3 minutes.

20. The foam composite of claim 12, wherein the at least one heavy metal is adsorbed from the water within less than 1 minute.

21. The foam composite of claim 12, wherein the at least one heavy metal is adsorbed from the water within less than 30 seconds.

22. The foam composite of claim 12, wherein the at least one heavy metal is zinc and/or cadmium.

23. The foam composite of claim 12, wherein the water is acidic.

24. The foam composite of claim 12, wherein the water is neutral.

25. The foam composite of claim 12, wherein the water is alkaline.

26. A method for the synthesis of the foam composite of claim 1 comprising:
1) etching Ti₃C₂Al in a solution of HF to form MXene Ti₃C₂T nanosheets as a powder;
2) synthesizing 1D cellulose microfibers by dissolving cellulose powder in an aqueous solution of NaOH and subsequently drying under vacuum to afford a cellulose powder;
3) mixing the nanosheet powder from step (1) and the cellulose powder from step (2) in water to afford an aqueous solution;
4) dissolving chitosan in an aqueous solution of acetic acid and adding the aqueous solution of nanosheet powder and cellulose powder from step (3) dropwise to form the chitosan-cellulose-MXene hydrogel; and
5) adsorbing the chitosan-cellulose-MXene hydrogel into a foam via an impregnation approach and annealing to afford the foam composite.

27. The method of claim 26, wherein the foam is polyurethane foam.
